(19) United States
(12) Patent Application Publication
(10) Pub. No.: US 2005/0217075 A1
(43) Pub. Date: Oct. 6, 2005

(54) Automatic opening and closing system for vehicle

(75) Inventor: Takashi Enomoto, Kiryu-shi (JP)

Correspondence Address: MCCORMICK, PAULDING & HUBER LLP, CITY PLACE II, 185 ASYLUM STREET, HARTFORD, CT, 06103, US

(73) Assignee: Mitsuba Corporation, Kiryu-shi (JP)

(21) Appl. No.: 11/086,221

(22) Filed: Mar. 22, 2005

(30) Foreign Application Priority Data
Mar. 23, 2004 (JP) 2004-83842

(51) Int. Cl. E05F 1/14

(52) U.S. Cl. 16/285

(57) ABSTRACT

Structure of an automatic opening and closing system for a vehicle is simplified, thereby reducing the cost. A base end of an arm member is swingably connected to a back door. One end of a cable is fixed to the base end of the arm member, and the other end of the cable is fixed to a distal end of the arm member. A drum is provided in a close side of the base end of the arm member and open side of the distal end, and is fixed to an output shaft of a drive unit and driven to be rotated by an electric motor. Middle part of the cable is wound around the drum, and when the electric motor is actuated, the cable is reeled onto the drum so as to be actuated in the direction in which the base end or the distal end approaches the drum.

### BACKGROUND OF THE INVENTION

1. Field of the Invention

The present invention relates to an automatic opening and closing system for a vehicle for automatically opening and closing an opening and closing member that is attached to a vehicle so that it can be opened and closed via hinges.

2. Description of Related Art

Conventionally, in a vehicle such as an automobile, there ubiquitously provided an opening and closing member such as a door, a trunk lid, or a back door that is attached to a vehicle via hinges so that it can be opened and closed. For example, in many vans, mini-vans, and the like, a back door is provided at the rear end of a vehicle so as to facilitate loading and unloading of baggage from the rear of the vehicle.

Generally, such back door is a top-hinged bottom-open type in which hinges are fixed to the rear end of the vehicle roof, and the back door opens and closes in the vertical direction with the opening and closing central axis of the hinges serving as the center. In this case, since the back door is widely raised up to the upper side of the vehicle, it is also called as, for example, a liftgate, or a rear hatch.

However, such back door is large and heavy in many cases, therefore performing opening and closing operations thereof is sometimes difficult, particularly for women and children. Particularly, in a fully opened state, the back door is widely raised up, therefore the operation becomes more difficult.

Thereat, under the circumstance that vehicles for family use such as mini-vans are increasing, there developed a vehicle on which an automatic opening and closing system for automatically opening and closing a back door is loaded such that even women and children can easily open and close it. Such automatic opening and closing system enables remote operation of the back door from a driver seat. Therefore, the demands for attachment of automatic opening and closing systems are not negligible because of the convenience.

Such automatic opening and closing system comprises a drive means such as an electric motor, and that the output of the electric motor is converted to opening or closing motion of the back door by a power transmission mechanism so as to perform an opening or closing operation of the back door. As the power transmission mechanism, for example, a rack and pinion type that comprises a pinion which is driven to be rotated by the electric motor and a rack connected with the back door via a rod or the like, and a sector gear type employing a sector gear instead of a rack are frequently employed. In these cases, when the pinion gear is driven to be rotated by the electric motor, the rack reciprocates linearly, or the sector gear is moved to swing, so as to operate the back door to open or close.

However, in these cases, a large load is applied to the engagement portion of the pinion and the rack or the sector gear from the back door. Therefore, the actuation sound generated from the engagement portion of gears increases, which is problematic. In addition, since a plurality of gears are employed for transmitting power, the structure thereof becomes complicated, thereby increasing the cost of the automatic opening and closing system.

Thereat, there developed a technique in which the output of the electric motor is transmitted to the back door by use of a power transmission element such as a chain, a belt, or a cable, instead of a rack or a sector gear. For example, in an automatic opening and closing system described in U.S. Pat. No. 6,367,864, there provided an arm member swingably connected with a back door, and a chain of which both ends are fixed to the distal ends of the arm member and which are disposed over a pair of sprockets provided at both end sides of the movement range of the arm member so as to be annularly disposed, wherein the drive sprockets over which part the chain is disposed is driven by an electric motor so as to operate the back door to open or close.

Meanwhile, in an automatic opening and closing system described in Japanese Patent Application Laid-Open (kokai) No. 2001-132329, a belt to which distal ends of an arm member are fixed is employed as a power transmission element, and one of the pulleys over which the belt is disposed is driven by an electric motor so as to operate the back door to open or close.

However, in such automatic opening and closing systems, the power transmission element actuated by an electric motor generates, in principle, only tension force. Therefore, in order to actuate the back door in the opening and closing direction, the power transmission element has to be guided from the opening direction side and the closing direction side with respect to the distal ends of the arm member. Thus, the structure thereof becomes complicated, for example, a pair of pulleys for converting the actuation direction of the power transmission element has to be provided at both ends of the movement range of the arm member, thereby increasing the cost.

### BRIEF SUMMARY OF THE INVENTION

An object of the invention is to simplify the structure of an automatic opening and closing system for a vehicle so as to reduce the cost thereof.

### BRIEF DESCRIPTION OF THE DRAWINGS

FIG. 1 is a side view showing the rear end of a vehicle equipped with an automatic opening and closing system for a vehicle, which is an embodiment of the present invention;

FIG. 2 is an explanatory view showing details of the automatic opening and closing system for a vehicle shown in FIG. 1;

FIG. 3 is an explanatory view showing a state in which a back door of the automatic opening and closing system for a vehicle shown in FIG. 2 is opened to a fully open position;

FIG. 4 is an explanatory view showing a modification example of the automatic opening and closing system for a vehicle shown in FIG. 2; and

FIG. 5 is an explanatory view showing a modification example of the automatic opening and closing system for a vehicle shown in FIG. 2.

### DETAILED DESCRIPTION OF THE INVENTION

Embodiments of the present invention will next be described in detail with reference to drawings.

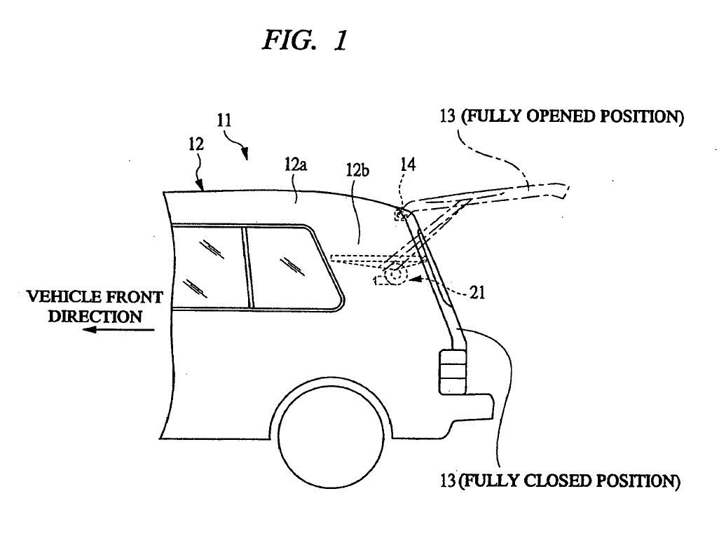

FIG. 1 is a side view showing the rear end of a vehicle equipped with an automatic opening and closing system for a vehicle, which is an embodiment of the present invention; and a back door 13 serving as an opening and closing member is provided at the rear end of a vehicle body 12 which constitutes the vehicle 11. Hinges 14 are attached to the rear end of a roof portion 12a of the vehicle body 12, and the back door 13 is attached to the vehicle body 12 via the hinges 14 so that it can be opened and closed in the vertical direction within an approximately 90 degree range between a fully closed position shown by solid lines in the drawing and a fully open position shown by chain lines in the drawing.

Automatic opening and closing systems for a vehicle 21 (hereinafter, referred to as the “opening and closing systems 21”) that are disposed in pillar portions 12b of the vehicle body 12 are provided in the vehicle 11, and the opening and closing systems 21 enable automatically opening and closing the back door 13.

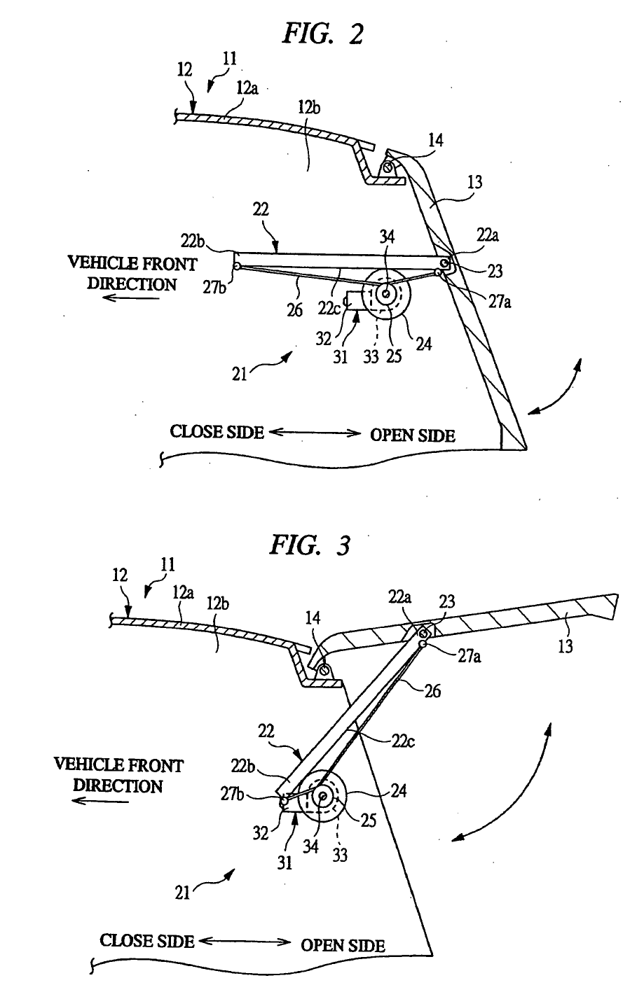

FIG. 2 is an explanatory view showing details of the automatic opening and closing system for a vehicle shown in FIG. 1, and FIG. 3 is an explanatory view showing a state in which the back door of the automatic opening and closing system for a vehicle shown in FIG. 2 is opened to the fully open position.

As shown in FIG. 2 and FIG. 3, the opening and closing system 21 has an arm member 22. The arm member 22 is formed into a rod-like shape, for example, by a steel material, and a base end 22a thereof is swingably connected to the back door 13 by a pin member 23. The pin member 23 is disposed such that the axial direction thereof is parallel to the axial direction of the hinges 14. Accordingly, the arm member 22 is swingable about the axis of the pin member 23 as the center and with respect to the back door 13 in the vertical direction of the vehicle 11.

A roller 24, serving as a support member, that is positioned in the open side with respect to a distal end 22b of the arm member 22 and in the close side with respect to the base end 22a of the arm member 22 is rotatably provided in the vehicle body 12, and a side portion 22c of the arm member 22 comes into contact with the outer peripheral surface of the roller 24 from the upper side of the vehicle 11. In other words, the arm member 22 is supported by the back door 13 at the base end 22a, and is supported by the roller 24 at the side portion 22c. Accordingly, when the back door 13 moves between the fully closed position and the fully open position, the arm member 22 is guided by the roller 24, and the movement track thereof is determined. Herein, the open side refers to the side toward which the back door 13 opens, which is the rear side of the vehicle in this case; and, on the contrary, the close side refers to the side toward which the back door 13 closes, which is the front side of the vehicle in this case.

A drum 25 serving as a guide member is provided in the opening and closing system 21. The drum 25 is disposed coaxially with the roller 24, and is always positioned in the open side with respect to the distal end 22b of the of the arm member 22 and in the close side with respect to the base end 22a, even when the arm member 22 is moved together with the back door 13. In other words, the drum 25 is always positioned between the distal end 22b and the base end 22a of the arm member 22. Meanwhile, the outer diameter size of the drum 25 is formed to be smaller than the outer diameter size of the roller 24, therefore, the outer peripheral surface of the drum 25 faces the side portion 22c of the arm member 22 with a predetermined distance therebetween.

Although the drum 25 is disposed coaxially with the roller 24 in the illustrated case, the structure is not limited thereto as long as the drum is disposed in the open side with respect to the distal end 22b of the arm member 22 and in the close side with respect to the base end 22a. When the roller 24 and the drum 25 are coaxially disposed, they may be integrally formed, or may be separately formed. The outer diameter of the drum 25 may be formed to be same as the outer diameter size of the roller 24.

A cable 26 serving as a power transmission element is disposed over an unillustrated cable guide groove formed on the outer peripheral surface of the drum 25. In this case, in order to cause the cable 26 to reliably engage with the drum 25, the cable 26 is disposed over the drum 25 a plurality of times. In other words, the cable 26 is wound around the drum 25 a plurality of times; and when the drum 25 rotates, one side of the cable 26 is reeled onto the drum 25, and the other side is reeled out from the drum 25.

One end of the cable 26 is guided to the open side with respect to the side of the drum 25 facing the arm member 22, i.e., the rear side of the vehicle, and is fixed by a fixture member 27a provided at the base end 22a of the arm member 22. Meanwhile, the other end of the cable 26 is guided to the close side with respect to the side of the drum 25 facing the arm member 22, i.e., the front side of the vehicle, and is fixed by a fixture member 27b provided at the distal end 22b of the arm member 22. In other words, the cable 26 is wound around the drum 25 at the middle part thereof, the one end is fixed to the base end 22a of the arm member 22, and the other end is fixed to the distal end 22b of the arm member 22.

A drive unit 31 is provided in the opening and closing system 21. When the drive unit 31 drives to rotate the drum 25, the cable 26 is actuated.

An electric motor 32 serving as a drive means is provided in the drive unit 31, and the output of the electric motor 32 is reduced to a predetermined revolution speed by a reduction mechanism 33 and transmitted to an output shaft 34. A motor that is forwardly and reversely rotatable such as a direct-current motor with brush, or a brushless motor is employed as the electric motor 32. Actuation of the motor is controlled by an unillustrated control device which receives a command signal from an unillustrated back-door opening and closing switch, so that the output shaft 34 can be rotated in both the forward and reverse directions. A device having a function as a CPU or a micro computer comprising, for example, a memory is employed as the control device.

An unillustrated electromagnetic clutch is provided in the drive unit 31. In accordance with a command from the unillustrated control device, the power transmission between the electric motor 32 and the output shaft 34 can be shut off and established by the electromagnetic clutch.

The above described drum 25 is fixed to the output shaft 34 of the drive unit 31, and the roller 24 is also attached thereto so as to be relatively rotatable with respect to the output shaft 34 of the roller 24. In other words, the drum 25 is fixed to the output shaft 34 so as to be rotatable with respect to the vehicle body 12, and is connected to the electric motor 32 via the output shaft 34, the reduction mechanism 33, and the electromagnetic clutch. When the electric motor 32 is actuated, the drum 25 is driven to be rotated by the electric motor 32, thereby rotating forwardly or reversely about the output shaft 34 as the center thereof.

In the structure of the illustrated case, the roller 24 is attached to the output shaft 34 so as to be relatively rotatable with respect to the output shaft 34, and is not driven to be rotated by the electric motor 32. However, when the drum 25 and the roller 24 have the same diameter, both of them may be driven by the electric motor 32 so that they can be integrally rotated.

Actuation of the opening and closing system 21 will next be described.

When the open side of the unillustrated back-door opening and closing switch is operated in a state in which the back door 13 is at the fully closed position as shown in FIG. 2, the electric motor 32 is actuated, thereby rotating the drum 25 in the opening direction, i.e., clockwise in the drawing. When the drum 25 rotates in the opening direction, part of the cable 26 between the fixture member 27b and the drum 25 is reeled onto the drum 25, and the cable 26 begins to be actuated in the opening direction. In other words, the cable 26 is actuated by the electric motor 32 via the drum 25. As a result, the arm member 22 is drawn by the cable 26 by the distal end 22b thereof while moving in the direction in which the distal end 22b approaches the drum 25.

Part of the cable 26 positioned between the fixture member 27a and the drum 25 is reeled out in an amount same as the reeled-in amount of the cable 26, therefore, the length of the cable 26 disposed between the fixture member 27a and the fixture member 27b is kept constant.

Herein, the actuation direction of the part of the cable 26 between the fixture member 27b and the drum 25, i.e., the direction of the tensile force caused by the cable 26 is deviated from the axial direction of the arm member 22. Therefore, turning force in the direction toward the drum 25 is applied to the arm member 22, with the pin member 23 serving as the center, by the component force of the cable tensile force. The turning force forces the arm member 22 on the roller 24, and the turning force is supported by the roller 24. As a result, the distal end 22b of the arm member 22 is drawn by the cable 26 while the movement direction is guided by the roller 24, and the arm member is moved toward the opening direction, i.e., toward the rear side of the vehicle while the inclination thereof is gradually increased. Then, the back door 13 is pushed in the opening direction by the arm member 22 so as to carry out the opening operation toward the fully opened position.

Inversely, when the close side of the unillustrated back-door opening and closing switch is operated in a state in which the back door 13 is at the fully opened position as shown in FIG. 3, the electric motor 32 rotates reversely, thereby rotating the drum 25 in the closing direction, i.e., counterclockwise in the drawing. When the drum 25 rotates in the closing direction, part of the cable 26 between the fixture part 27a and the drum 25 is reeled onto the drum 25, and the cable 26 begins to be actuated in the closing direction. As a result, the arm member 22 is drawn by the cable 26 by the base end 22a thereof while moving in the direction in which the base end 22a approaches the drum 25.

Part of the cable 26 positioned between the fixture member 27b and the drum 25 is reeled out in an amount same as the reeled-in amount of the cable 26, therefore, the length of the cable 26 disposed between the fixture member 27a and the fixture member 27b is kept constant.

Herein, since the fixture member 27a is adjacent to the pin member 23, turning force caused by component force of the cable tensile force is not applied to the arm member 22, and the weight of its own causes the arm member 22 to come into contact with the roller 24. As a result, the distal end 22a of the arm member 22 is drawn by the cable 26 while the movement direction is guided by the roller 24, and the arm member is moved toward the closing direction, i.e., toward the front side of the vehicle while the inclination thereof is gradually reduced. Accordingly, the back door 13 is drawn by the arm member 22 so as to carry out the closing operation toward the fully closed position.

As described above, in the opening and closing system 21, the cable 26 that is fixed to the base end 22a and the distal end 22b of the arm member 22 is wound around the drum 25 that is disposed between the base end 22a and the distal end 22b of the arm member 22, and the back door 13 is opened or closed by driving to rotate the drum 25 by the electric motor 32. Therefore, tension force can be generated in the cable 26 by the one drum 25 in the opening direction and the closing direction. More specifically, in either case in which the back door 13 is subjected to the opening operation or closing operation, the cable 26 is actuated toward the drum 25 that is disposed between the base end 22a and the distal end 22b of the arm member 22. Therefore, tension force can be generated in the cable 26 by the one drum 25 in the opening direction and the closing direction. Thus, members such as pulleys for converting the actuation direction of the cable 26 are not required to be provided at both ends of the movement range of the arm member 22, therefore the structure of the opening and closing system 21 can be simplified so as to reduce the cost.

Moreover, in the opening and closing system 21, since the back door 13 is actuated by the cable 26 instead of, for example, a pinion and rack, or a sector gear; actuation noise of gears is not generated, thereby reducing the actuation noise of the opening and closing system 21.

Furthermore, in the opening and closing system 21, since the cable 26 is actuated by driving to rotate the drum 25 by the electric motor 32; the structure for actuating the cable 26 can be simplified, thereby further reducing the cost of the opening and closing system 21.

Furthermore, in the opening and closing system 21, since the arm member 22 is also driven by the roller 24, which is driven to be rotated by the electric motor 32, in addition to the tension force of the cable 26; the power of the electric motor 32 can be efficiently transmitted to the arm member 22, i.e., for example, the friction resistance between the roller 24 and the arm member 22 is reduced. Moreover, since the roller 24 and the drum 25 are coaxially disposed and fixed to the one output shaft 34, the structure for driving to rotate the roller 24 and the drum 25 by the electric motor 32 can be simplified.

Moreover, when opening or closing of the back door 13 is stopped in course of the operation, unexpected movement of the back door 13 in the opening or closing direction can be prevented, even when the electric motor 32 is stopped, as long as the electromagnetic clutch is in a power transmission state.

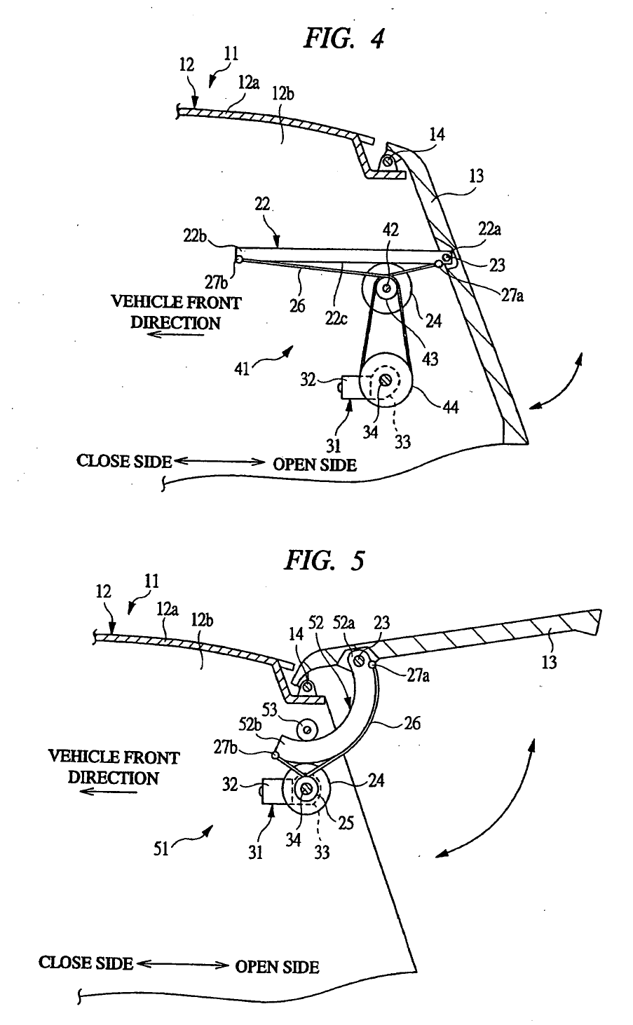

FIG. 4 is an explanatory view showing a modification example of the automatic opening and closing system for a vehicle shown in FIG. 2.

In the opening and closing system 21 shown in FIG. 2, the guide member is the drum 25 that is fixed to the output shaft 34 of a drive unit 31 and driven to be rotated by the electric motor 32. However, in an automatic opening and closing system 41 for a vehicle (hereinafter, referred to as the “opening and closing system 41”) shown in FIG. 4, the guide member is a pulley 43 that is provided in the vehicle body 12 coaxially with the roller 24 and rotatably supported by a rotating shaft 42.

Furthermore, a drum 44 serving as a drive body is provided in the opening and closing system 41, and the drum 44 is fixed to the output shaft 34 of the drive unit 31 so as to be driven to be rotated by the electric motor 32. In the illustrated case, the drum 44 and the drive unit 31 are disposed in the rear side of the vehicle with respect to the pulley 43, and the cable 26 is disposed over the drum 44 from the fixture members 27a and 27b and via the pulley 43. Also in this case, the cable 26 is wound around the drum 44 a plurality of times.

In the manner same as that of the opening and closing system 21 shown in FIG. 2, when the electric motor 32 is actuated and the drum 25 rotates, the cable 26 is reeled onto the drum 44, the arm member 22 is drawn by the cable 26 and moved while the movement direction thereof is guided by the roller 24, thereby carrying out the opening or closing operation of the back door 13.

More specifically, in the opening and closing system 41, the cable 26 fixed to the base end 22a and the distal end 22b of the arm member 22 is disposed over the pulley 43 such that tension force can be generated in the cable 26 in the opening direction and the closing direction; and the drive unit 31 for driving to rotate the drum 44 by disposing the cable 26 over the drum 44, which is disposed away from the pulley 43, via the pulley 43 is disposed at the position away from the pulley 43 and the arm member 22.

As described above, in the opening and closing system 41, since the cable 26 is disposed, via the pulley 43, over the drum 44 provided away from the pulley 43 over which the cable 26 fixed to the arm member 22 is disposed, and the drum 44 is driven to be rotated by the electric motor 32; therefore, the electric motor 32 can be disposed at a position away from the pulley 43 and the arm member 22. Therefore, degree of freedom in disposition of the electric motor 32 and the drive unit 31 including the motor is improved, thereby improving the loadability of the opening and closing system 41 with respect to the vehicle 11, i.e., for example, when disposing the electric motor 32 and the drive unit 31 in the pillar portion 12b is difficult in terms of space, the electric motor 32 and the drive unit 31 can be disposed in an empty space, e.g., near an unillustrated wheelhouse.

In FIG. 4, the members corresponding to the already described members are denoted by the same reference numerals.

The present invention is not limited to the above described embodiments, and it goes without saying that various modifications can be made without deviating from the scope of the invention. For example, in the above described embodiments, the opening and closing member is the back door 13 that is attached to the rear end of the vehicle body 12 so as to be able to be opened and closed in the vertical direction, however, the opening and closing member is not limited thereto and may be, for example, a side opening door, as long as the opening and closing member is attached to the vehicle body 12 via a hinge(s) 14 so as to be able to be opened and closed.

Also, in the above described embodiments, the drive unit 31 is fixed to inside of the pillar portion 12b of the vehicle body 12, however, the position is not limited thereto, and the drive unit may be disposed inside the roof portion 12a.

Furthermore, in the above described embodiments, the arm member 22 is formed into a rod-like shape, however, the shape is not limited thereto, and the arm member may be formed into a shape which curves from a base end 52a to a distal end 52b such as an arm member 52 employed in an automatic opening and closing system 51 for a vehicle shown in FIG. 5. In FIG. 5, the members corresponding to already described members are denoted by the same reference numerals.

Furthermore, in the above described embodiments, the support member is the rotatable roller 24, however, the support member is not limited thereto, and, as long as it can support the arm member 22, may be a slider or the like which slidably comes into contact with the arm member 22.

Furthermore, although the support member is provided only in the side lower than the arm member 22 in the vehicle 11, it is not limited thereto, and, for example as shown in FIG. 5, a roller 53 serving as a second support member may be provided in the upper side of the vehicle 11 with respect to the arm member 52. When the arm member is formed into a rod-like shape, the distance between the support members is designed to be variable according to inclination of the arm member.

Furthermore, in the above described embodiments, the cable 26 is employed as the power transmission element, however, the power transmission element is not limited thereto, and may be a wire, a chain, a belt, or the like. Moreover, the guide member or the drive body is not limited to a pulley or a drum, and a member having a shape suitable for the power transmission element can be employed, for example, when a chain is employed as the power transmission element, a sprocket may be employed. Furthermore, when the guide member is employed as the pulley 43 shown in FIG. 4, it can be replaced by a slider or the like that slidably comes into contact with the cable 26.

Furthermore, in the above described embodiments, both ends of the one cable 26 are fixed to the arm member 22, however, the structure is not limited thereto, and a first cable of which one end is fixed to the base end 22a of the arm member 22 and a second cable of which one end is fixed to the distal end 22b may be provided, wherein the cables are wound around the drum 25 or 44 in the direction opposite to each other, and the other ends are fixed to the drum 25 or 44.

According to the present invention, in either case in which the opening and closing member is subjected to the opening operation or closing operation, the power transmission element is actuated toward the guide member that is disposed between the base end and the distal end of the arm element. Therefore, tension force can be generated in the power transmission element by one guide member in the opening and closing direction. Thus, members such as pulleys for converting the actuation direction of the power transmission element are not required to be provided at both ends of the movement range of the arm member, therefore the structure of the automatic opening and closing system for a vehicle can be simplified so as to reduce the cost thereof.

Moreover, according to the present invention, since the opening and closing member is actuated by the power transmission element instead of, for example, a pinion and rack or a sector gear; actuation noise of gears is not generated, thereby reducing the actuation noise of the opening and closing system for a vehicle.

Furthermore, according to the present invention, since the power transmission element is actuated by driving to rotate the guide member by the drive means; the structure for actuating the power transmission element can be simplified, thereby further reducing the cost of the opening and closing system for a vehicle.

Furthermore, according to the present invention, since the power transmission element is disposed, via the guide member, over the drive body provided away from the guide member, and the drive body is driven to be rotated by the drive means; therefore, the drive means can be disposed at a position away from the guide member and the arm member. Therefore, degree of freedom in disposition of the drive means is improved, thereby improving the loadability of the opening and closing system for a vehicle with respect to the vehicle.

Furthermore, according to the present invention, since the arm member is also driven by the roller, which is driven to be rotated by the drive means, in addition to the tension force of the power transmission element; the power of the drive means can be efficiently transmitted to the arm member, i.e., for example, the friction resistance between the roller and the arm member is reduced. Moreover, since the roller and the guide member, which is driven to be rotated by the drive means, are coaxially disposed, the structure for driving to rotate the roller by the drive means can be simplified.

1. An automatic opening and closing system for a vehicle for automatically opening and closing an opening and closing member which is attached to a vehicle body via a hinge so as to be able to be opened and closed, wherein the automatic opening and closing system for a vehicle comprises:
an arm member of which base end is swingably connected to the opening and closing member;
a support member which is provided in the vehicle body for supporting the arm member;
a power transmission element of which one end is fixed to the base end of the arm member and the other end is fixed to a distal end of the arm member;
a guide member which is disposed in an open side with respect to the distal end of the arm and in a close side with respect to the base end of the arm member, for guiding the power transmission element; and
a drive means for actuating the power transmission element in the direction in which the distal end of the arm member approaches the guide member and the direction in which the base end of the arm member approaches the guide member.

2. The automatic opening and closing system for a vehicle according to claim 1, wherein
the drive means drives to rotate the guide member so as to actuate the power transmission element.

3. The automatic opening and closing system for a vehicle according to claim 1, further comprising:
a drive body which is provided away from the guide member and over which the power transmission element is disposed via the guide member; wherein
the drive body is driven to be rotated by the drive means so as to actuate the power transmission element.

4. The automatic opening and closing system for a vehicle according to claim 1, wherein
the support member is a rotatable roller.

5. The automatic opening and closing system for a vehicle according to claim 2, wherein
the support member is a rotatable roller.

6. The automatic opening and closing system for a vehicle according to claim 3, wherein
the support member is a rotatable roller.

7. The automatic opening and closing system for a vehicle according to claim 4, wherein
the guide member and the roller are coaxially disposed.

8. The automatic opening and closing system for a vehicle according to claim 5, wherein
the guide member and the roller are coaxially disposed.

9. The automatic opening and closing system for a vehicle according to claim 6, wherein
the guide member and the roller are coaxially disposed.

10. The automatic opening and closing system for a vehicle according to claim 4, wherein
the roller is driven to be rotated by the drive means.

11. The automatic opening and closing system for a vehicle according to claim 7, wherein
the roller is driven to be rotated by the drive means.
